(19) United States
(12) Patent Application Publication
(10) Pub. No.: US 2008/0120197 A1
(43) Pub. Date: May 22, 2008

(54) Browser Having Resident Software Tools

(76) Inventors: Aron Markowitz, Monroe, NY (US); Shrage Smilowitz, Monroe, NY (US)

Correspondence Address: DIEHL SERVILLA LLC, 77 BRANT AVE, SUITE 210, CLARK, NJ, 07066, US

(21) Appl. No.: 11/943,253

(22) Filed: Nov. 20, 2007

Related U.S. Application Data
(60) Provisional application No. 60/866,704, filed on Nov. 21, 2006.

(51) Int. Cl. G06Q 30/00

(52) U.S. Cl. 705/26

(57) ABSTRACT

A browser having a resident shopping cart tool, a resident product comparison tool and/or a resident wish list tool is disclosed. These tools can either reside permanently with the browser or be downloaded to the browser for use. For example, the tools can be downloaded from a central site to the browser on an as needed basis. Accordingly, the present invention provides a user of the browser with ease of use, a consistent internet experience and an improved internet experience.

### CROSS-REFERENCE TO RELATED APPLICATIONS

This application claims the benefit of U.S. Provisional Application No. 60/866,704, filed Nov. 21, 2006, which is incorporated herein by reference.

### BACKGROUND OF THE INVENTION

The present invention relates to a system and method for providing communications and services via the Internet.

Existing communications and services provided on the Internet are largely based on HTML protocols. The systems and methods that provide the communications and services have many limitations. For example, from a user's perspective, a user needs to determine how each site works. Even if customization of the site is permitted, a user needs to customize each site individually. Further, some tools are available on one site, while other tools are available on a different site. This can make Internet usage time consuming as well as make the experience on the internet difficult.

As such, new browsers and methods of browsing are needed.

### SUMMARY OF THE INVENTION

In accordance with one aspect of the present invention a software application is provided. The software application is preferably a browser that includes means for browsing the world wide web or the internet and another tool. The tool can be a shopping cart tool, a product comparison tool or a wish list tool.

In accordance with a further aspect of the invention, the software application is resident on a computer. The software application can also include all of the normal tools provided with a browser.

The tools can be permanently resident on the browser or can be downloaded from a site. For example, a central site provided the tools can be accessed by browsers to download the tools from.

As explained herein, files at internet sites being visited are preferably stored in a standardized format. The format is preferably an XML format. The browser of the present invention can therefore use its resident tools to access multiple web sites.

The present invention provides users of the browser with an improved internet experience. The user's experience will be more consistent.

### DESCRIPTION OF THE DRAWINGS

FIG. 1 illustrates an Internet based system in accordance with one aspect of the present invention.

FIG. 2 illustrates a method of browsing in accordance with another aspect of the present invention.

FIG. 3 illustrates a method of controlling communications with an external storage device that is associated with the browser in accordance with another aspect of the present invention.

FIG. 4 illustrates a method of saving a link and information specified by the link in accordance with a plurality of options.

FIG. 5 illustrates a screen provided to a user in accordance with one aspect of the present invention.

FIG. 6 illustrates a web site architecture in accordance with one aspect of the present invention.

FIG. 7 illustrates a system and method of retrieving product information from one or more Internet sites in accordance with one aspect of the present invention.

FIGS. 8 and 9 illustrate a plurality of xml files in accordance with one aspect of the present invention.

FIGS. 10 to 16 illustrate a set up for a server in accordance with one aspect of the present invention.

FIG. 17 illustrates a system and method of creating a wish list in accordance with an aspect of the present invention.

FIG. 18 illustrates a system and method of obtaining linked product information from multiple sites on the Internet in accordance with an aspect of the present invention.

FIG. 19 illustrates a system and method of comparing information obtained from the Internet concerning a product.

FIG. 20 illustrates the comparison of products obtained as a result of the system and method illustrated in FIG. 7.

FIGS. 21 to 23 illustrate various screen shots provided by a browser in accordance with one aspect of the present invention.

FIG. 24 illustrates a browser in accordance with another aspect of the present invention.

FIG. 25 illustrates a further aspect of the present invention.

### DESCRIPTION OF A PREFERRED EMBODIMENT

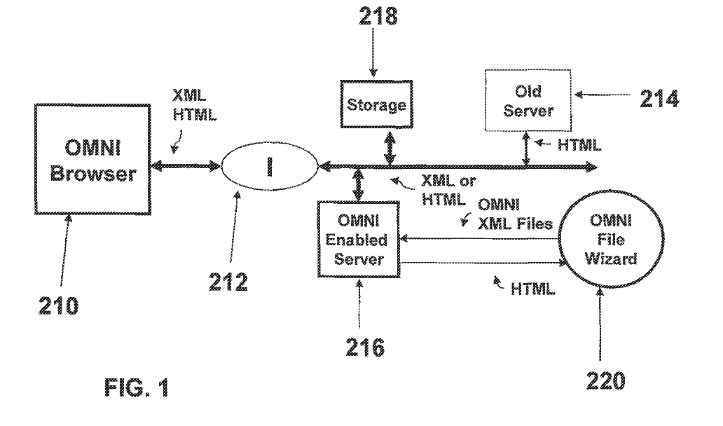

FIG. 1 illustrates a system in accordance with one aspect of the present invention. The system includes a browser 210 which is connected to the internet 212.

The browser 210, in accordance with one aspect of the present invention, is able to request, read and interpret HTML and XML files. The browser 210 is therefore able to communicate with servers 214 having information stored in HTML files. The browser 210 can request and receive the HTML files from servers 214, interpret the tag fields and display and otherwise use the HTML files, just as today's browsers can. Thus, the browser 210 can communicate with servers in the same manner as the Internet Explorer browser or AOL's browser.

Referring to FIG. 1, the browser 210 also communications with one or more servers 216 and a storage device 218. The server 216 maintains files in XML format. The server 216 can also maintain other files, or the same files, in HTML format. The server 210 can communicate with the server 216 to read or write either XML files or HTML files.

In accordance with another aspect of the present invention, the browser 210 is configured to read specially formatted XML files stored on the server 216. These specially formatted XML files are also referred to as a schema, and include the site.xml file and the products.xml file discussed later on.

The browser 210 can also communicate with a storage device 218. All data in the XML files provided to the browser 210 is selectable, linkable and storable on the storage device 218.

The server 216 preferably maintains files in a predetermined XML format or schema. The preferred schema is the site.xml and products.xml files. These files can be created automatically with a file creation wizard 220. An operator of the server 216 can load the server's 216 files into the file creation wizard 220 and automatically create a special XML schema to be used by the browser 210. Alternatively, the XML files can be created by hand. Of course any server, even server 214 can generate and transmit the site.xml and products.xml files or any other agreed to standardized XML schema.

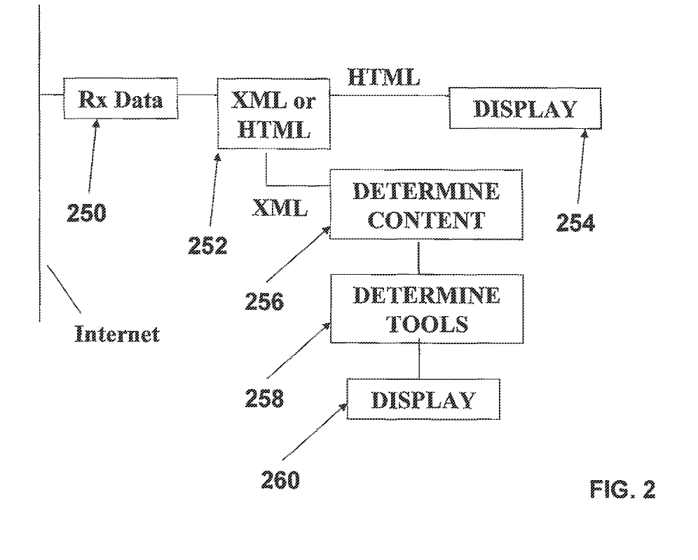

FIG. 2 illustrates a process in accordance with one aspect of the present invention. In step 250, the browser 210 receives data from the internet. In step 252 it is determined whether the data is HTML or XML content. If the data is HTML content, in step 254, the browser 210 displays the data on a screen, as is well known today.

If the data is XML content, then in step 256 the browser 210 determines whether the received data is in the preferred recognizable schema or not, that is, whether there are recognized files such as the site.xml file, the product.xml file and any other standardized files provided. If the data is not in a recognizable standardized format, then the XML data is displayed. If the data is in a recognizable standardized format, then in step 258 the content of the XML file is determined and appropriate tools are selected. The content and/or the tools are then displayed in step 260.

The tools selected in step 258 depend on the content of the XML data which can be recognized, by example, from the site.xml file. Thus, if the content category is products, the one or more tools selected by the browser 210 in step 258 and displayed in step 260 includes viewing information, comparing information, shopping cart, ordering products and paying for products or any other e-commerce tool. If the content category is services, the one or more tools selected by the browser 210 in step 258 and displayed in step 260 includes viewing information, comparing information, shopping cart, ordering services and paying for services or any other e-commerce tool.

When the content category of the standardized XML data is banking, the one or more tools selected by the browser 210 in step 258 and displayed in step 260 includes viewing information, paying bills, and transferring funds or any other known banking tool.

When the content category of the standardized XML data is news, the one or more tools selected by the browser 210 in step 258 and displayed in step 260 includes viewing information, selecting news sources and selecting news topics or any other known news tool.

When the content category of the standardized XML data is albums, the one or more tools selected by the browser 210 in step 258 and displayed in step 260 includes viewing pictures, downloading pictures and transferring pictures or any other known picture tool.

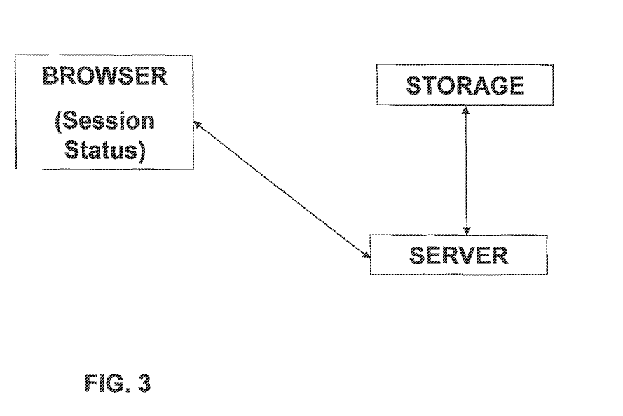

Referring to FIG. 3, in accordance with another aspect of the present invention, the browser 210 limits or restricts communications between servers 216 and the browser 210 and the servers 216 and storage 218. When the browser 210 receives the XML data from the server 216 and the browser enables communications between the server 216 and the storage 218 only when the browser 210 and the server 216 are connected or in session. The browser 210 maintains a status of when there is a session with any server 216, as shown in FIG. 3.

The server 216 communicates with the storage 218 to be able to store any and all information. For example, receipts when purchasing a product or information on products can be stored on the storage 218. Emails and instant messages can be sent from the server 216 to the storage 218 having information concerning the browser 210 activities. In accordance with one aspect of the present invention, these communications between the server 216 and the storage 218 are restricted to when the browser 210 and the server 216 are in session or communicating. When the session is over, communications are prohibited.

The communications between the server 216 and the browser 210 can also be limited or restricted to times when the server 216 and the browser 210 are in session.

The communications between the server 216 and the browser 210 or between the server 216 and the storage 218 can also be limited or restricted to communications that are made in a standardized XML schema or file format. Thus, in accordance with this aspect of the invention, if the server 216 attempts to communicate with either the browser 210 or the storage 218 in anything that is not a standardized XML schema or file format, the communication is prohibited.

This restriction of communication provides greater security as a server 216 can only communicate during a session with the browser 210 and/or in an agreed to, standardized format.

This can be implemented in a number of ways. For example, the browser 210 can give a ticket to a server 216 that expires after a certain amount of time. The server 216 will only be allowed to communicate with the browser 210 and the server 216 when the ticket is valid. After expiration of the ticket, no communications are allowed.

In accordance with a further aspect of the present invention, the browser 10 can perform all of the processes specified in provisional patent application Ser. No. 60/761,098, filed on Jan. 13, 2996, which is hereby incorporated by reference.

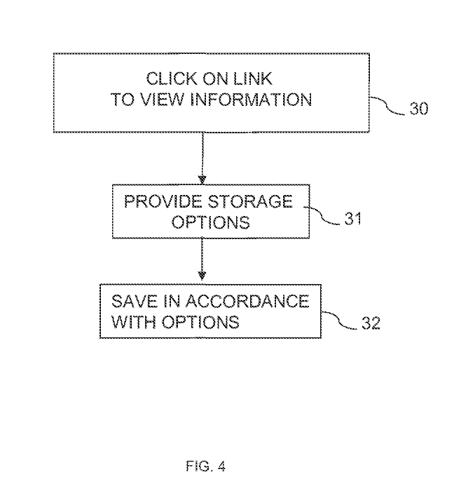

In accordance with one aspect of the present invention, a method of linking to internet files is provided. A user on the browser 210 accesses a web site maintained on the servers 216. As shown in FIG. 4, in step 30, the information from a web site maintained on the servers 216 specified by a link in a file is viewed. This step 30 is well known. In step 31, a software application on the browser 210 provides a user with several options on how to store the associated information. In step 32, the application software causes the information associated with the specified link to be saved in accordance with the options selected by the user. In accordance with a preferred embodiment of the present invention, the following options are presented by the application software: saving only the link; saving a copy of the information in the file and the link; and saving only the information in the file.

The software application preferably provides an option for each web site visited.

The information and/or the link, in accordance with the specified option, can be saved in a storage medium local to the browser 210. Alternatively, the software application can cause the information and/or the file to be saved in the storage medium 218 remote from the computer in accordance with the specified option.

In accordance with one aspect of the present invention, the file referred to in the link is in xml format.

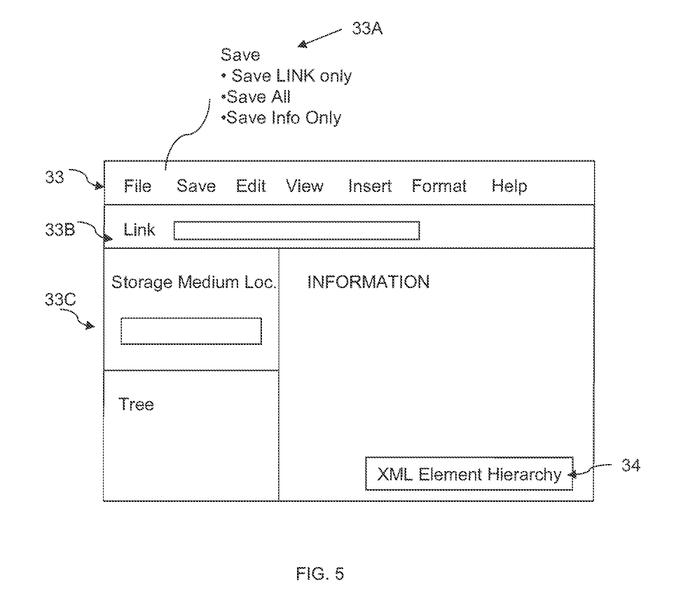

A screen that is provided on the browser 210 is illustrated in FIG. 5. A menu bar 33 is provided. The standard items in a menu can be provided. A SAVE menu command is preferably placed in the edit menu, but it could be provided anywhere or could be a command button located elsewhere. When the EDIT menu item is clicked, a list of various submenu options is provided, including by way of example only, UNDO, CUT, COPY PASTE and the SAVE menu command. The SAVE menu command specifies the options for saving information are provided underneath the SAVE menu item. The list of submenu options is illustrated as 33A and includes SAVE LINK, SAVE SNAPSHOT, and MERGE. A save function can also be performed by dragging a selection into a storage folder.

The link to the web site being viewed is specified in a text box at 33B. Another text box 33C is provided. The location of the storage medium that the information is to be stored in is specified in text box 33C.

Alternatively and preferably, however, the location of the storage medium, is stored in the browser settings section, and it goes together with the login. This way the browser knows where to store, history, receipts and all other storage that happens automatically. The location of the storage medium is preferably in a central provider on the internet.

When the SAVE LINK menu item (or other control item such as a command button) is selected, the software application on the browser 210 that caused the screen in FIG. 5 to be displayed, obtains the link information from the current selection on the screen and stores that link in a storage medium located at the address specified in the configuration settings sections to the current login. That location can either be local to the computer that the information is displayed on or can be remote to that computer. When the SAVE INFO menu item (or other control item) is selected, the software application obtains the information (at least part of which is being displayed in the right hand side of the screen) and stores that information in a storage medium located at the address specified in text box 33C. When the SAVE ALL menu item (or other control item) is selected, the software application obtains the information and the link and stores that information in a storage medium located at the address specified in text box 33C.

Of course, the options for saving can be provided in a number of additional ways. For example, a group of command buttons can be provided on the screen for the user to select. Saving would then be implemented in accordance with the selected command button.

In accordance with one aspect of the present invention, the information in the right hand portion of the screen is displayed from a xml file. The screen of FIG. 5 also includes a text box 34 that specifies the hierarchical xml format of information from the displayed information.

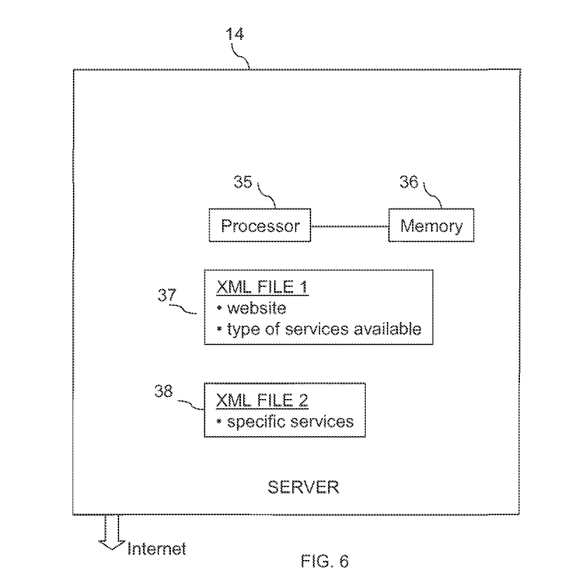

A system for linking to internet files is provided. The system includes first means for causing information from a web site specified by a link to be displayed and second means for providing two or more options, the two or more options specifying what to save. It also includes third means for selecting one of the options and fourth means for saving information from the web site, the link or both in accordance with the selected option. Each of these means is provided by a software application that is operable on the processor 35 shown in FIG. 6.

In accordance with another aspect of the present invention a web site is provided. The web site is maintained on any one of the servers 216. Referring to FIG. 6, the web site or the server 14 includes a processor 35 and a storage medium 36 connected to the processor as is well known. In accordance with one embodiment of the present invention, the storage medium stores one or more files 37 and 38 in xml format that specify the web site and one or more types of services available at the web site and stores one or more files in xml format that specify the specific services available for each of the types of services. In an alternative embodiment, all of this information can be provided in a single file, preferably in xml format. These files are preferably provided in a standardized format recognizable by the browser 210 and the server 218.

The types of services can include providing news and selling products. Other types of services can also be included. By way of example, album listings, forms and messaging can also be provided.

In accordance with one aspect of the present invention, where the type of service available is selling products, the file that specifies the specific services available includes a list of a plurality of products available from the web site. A description of each of the plurality of products can also be included in the specific services. The description can include that product name, the product description, size, color, price as well as other information about the product or manufacturer. The product description can be provided by a link to the manufacturer's web site, thereby obviating the need to write a separate product description.

The information provided in xml format can be provided in two files 37 and 38, a single file or more than two files.

A file that specifies a type of software utility that can read the one or more files in xml format that specify the web site and one or more types of services available at the web site and that can read the one or more files in xml format that specify the specific services available for each of the types of services can also be provided.

In accordance with another aspect of the present invention, a method for a web site to communicate is provided. In a first step, one or more files in xml format that specify the web site and one or more types of services available at the web site are transmitted. The transmission is made in response to a request for services from a user on the internet. In a second step, one or more files in xml format that specify the specific services available for each of the types of services are transmitted. The information transmitted can be an entire file or a portion of the file. Alternatively, these steps can be performed as a single step wherein the information is contained in one or more files that are transmitted in a single step.

The types of services specified in the file includes providing news, selling products, album listing, forums and messaging. As before, the specific services can include a list of a plurality of products available from the web site and a description of each of the plurality of products can be included in the specific services.

The method can also include the step of transmitting a file that specifies a type of software utility that can read the one or more files in xml format that specify the web site and one or more types of services available at the web site and that can read the one or more files in xml format that specify the specific services available for each of the types of services.

Communications with the servers 216 suffer from the drawbacks previously mentioned. In accordance with one aspect of the present invention, XML files are created at one or more sites, such as at servers 216. The created XML files are then used to communication information and to provide services with the browser 210 and the storage 218.

XML is a known standard. It stands for Extensible Markup Language. XML was designed to describe data. XML is a markup language like HTML, but XML tags are not predefined. Instead a user defines their own tags. Thus, XML is self describing and extensible. XML uses a DTD (Document Type Definition) or an XSD to formally describe data. In general, XML is not a replacement for HTML and XML and HTML were designed with different goals. XML was designed to describe data and to focus on what data is whereas HTML was designed to display data and to focus on how data looks.

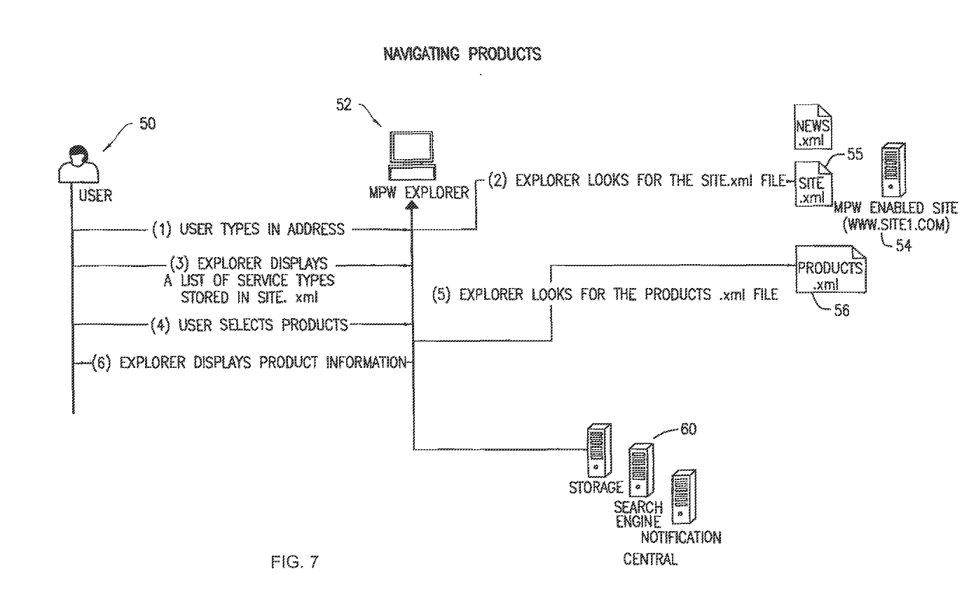

Referring to FIG. 7, a system and method for navigating products in accordance with one aspect of the present invention is illustrated. A user 50 at a terminal 52 (a browser in accordance with the present invention) communicates with a site 54 via the Internet. The site 54 is enabled in accordance with a convention specified in accordance with one aspect of the present invention. The site 54 maintains a number of XML files. A site.xml file provides a list of services provided by the site 54. A products.xml file describes products that are offered through the site. The description, as previously described, can include a product name, a description, color, size, price, etc. Further, this information can be provided in a single xml file or in more than two xml files.

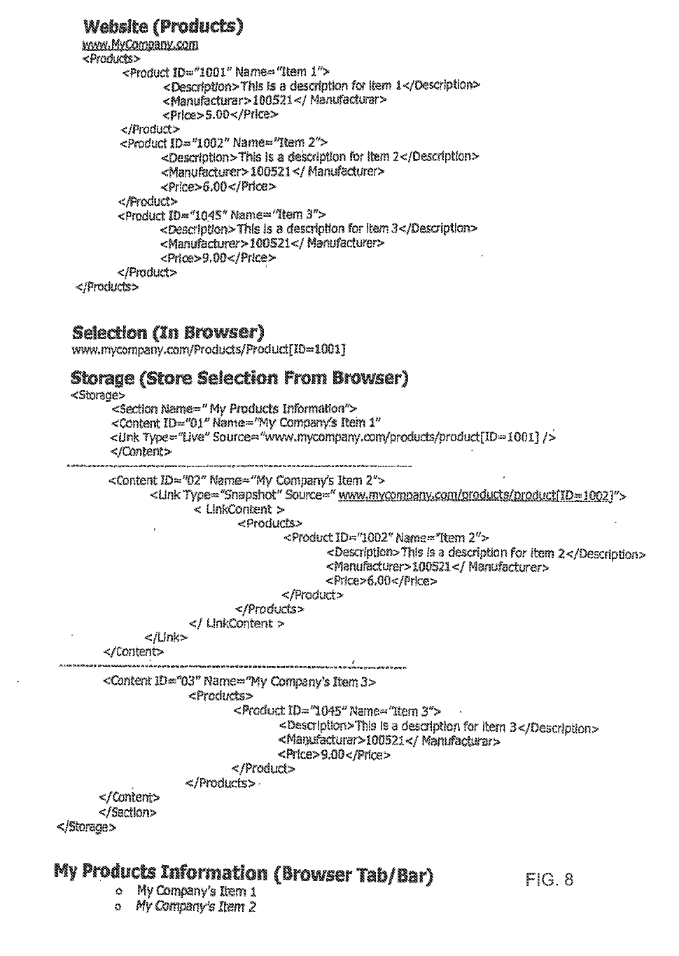

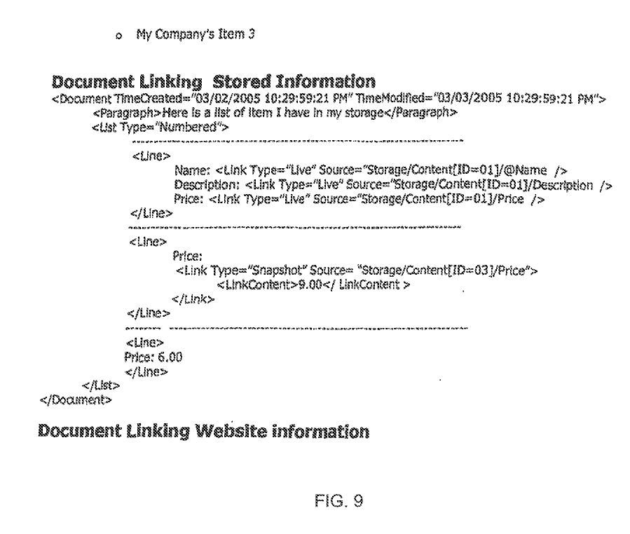

FIGS. 8 and 9 are representative of xml files 37 and 38 in accordance with one aspect of the present invention. These files are in a standardized format or schema. The information provided includes a list of products available in the My Products Information section and a list of product descriptions in the WEB SITE (PRODUCTS) section. It also includes information about linked information.

In accordance with one aspect of the present invention, a method and system for navigating products is provided. Referring to FIG. 7, in step (1) the user 50 types in an address into the terminal 52. The address is preferably typed into a browser. The browser on the terminal 52 uses the address to search for a site at the specified address on the Internet in step (2). The site 54 responds by sending the site.xml file to the terminal 52 and the terminal 52, in step (3), displays a list of services derived from the site.xml file. In step (4), the user 50 selects products of interest, and in step (5), the terminal 52 accesses the step 54 via the Internet to search for the products.xml file. This file is sent to the terminal 52 and the terminal 52 extracts information relating to the selected products of interest. Of course, as previously mentioned, the information in the site.xml file and in the products.xml file can be combined into a single file. Also, all or part of a file can be transmitted.

The browser stored on the terminal 52 is different than the browsers found on today's computers, such as Internet Explorer or Netscape, which operate on HTML codes. The functionality of the browser stored on the terminal 52 is to provide a platform to browse web sites and content of a given web site. A web site is an online site that belongs to a specific organization described in the site.xml file. The site can reside on one web address or spread between multiple locations. After the browser recognizes the services and documents provided by the web site it will be responsible for the several actions, which are summarized in the following:

Messages: Sending and receiving the messages between the site server, central, browser and client application.

Static and Dynamic Content: Static content means the actual xml data and format of the data that the browser or the client expects to receive from the site. The site can create the content dynamically as long as the expected data is delivered.

If the client wants to receive dynamic content, for example it wants to search data using xPath, the browser will try to run that query against the server, if the server recognizes that query it will provide the resulting content, if the server does not understand it, the browser will receive the full static content and filter the content locally.

Launching the application: The browser launches an application on the client based on the service or document of the site. Since the browser will not be the actual application that provides functionality based on received content, the actual functionality will be provided by the specific application that knows how to read the content of the site. The browser will need to know what application to load. This will work almost how file extensions work in windows. MPW Central will have a database of all service types a site can provide, each service type will be linked to a client application id. When the browser first visits a site it will look for the service provided by the site, if it recognizes the type of service it will try to launch that application.

Message flow: After the browser launches the client application, it is still responsible to route all messages between the client app and the server, besides the Messages that the client sends directly to the browser, such as a call to Store data and the actual data to store.

Client requirements: XML path for each selected element I so the user can save it to the storage with Full Context information.

Documents: Manage documents provided by sites or applications

Storage: Manage storage for the site, application and user. Storage can be provided at a central storage, a portable storage and storing content.

Authentication: Authenticate the user to get user's profile.

Profile: Direct profile information from central—web site and application

Search: Search site content, and stored content The browser stored on the terminal 52 must be able to process xml files to perform all of these applications. The browser 52 should allow at least the following activities: Navigate; Search; Display; Filter; Selection; Link; Archive and Notification.

The browser 52 should include navigation tools, including an address bar, a tree view of services and sub elements, a custom templated view of services and sub elements. The browser 52 allows navigation between web sites, between services of each web site by providing an address bar where the user can type in an address location, or a location and filter statement. Alternatively, the browser can display an hierarchical view of services and element in a service, so the user can navigate by selecting a node in the tree, or navigation can be provided by a custom template as discussed in the viewing section.

The browser should provide search capabilities. The searching can be against the current web site viewed, or against the whole internet. The Search options are based on the schema type the user is searching by, so a list of options is displayed for the user such as Products, News, Music, Books etc. when a user selects an option, the appropriate search box is launched. Search options can be automatically displayed based on the schema currently viewed.

The browser 52 should be able to display information. The browser 52 preferably has different display views, based on the schema an appropriate view is launched. Preferably, there is a simple view for each schema, which displays just the data in an hierarchical and tabular view.

The browser 52 also preferably has a design view, which allows the user to specify a template to use for a specific schema.

The templates can be preset and pre-downloaded for a schema or downloaded on-demand meaning it's downloaded when viewing. By allowing on-demand downloads of templates, a site can specify a recommended template which points to a publicly available template, the browser may download such templates automatically if the user permits it in the browser user's settings.

The browser 52 preferably allows a user to switch between simple or design view.

The browser 52 preferably includes a view function. The view can be a whole list of elements, a list of elements resulting from a filter or a single element resulted from a filter.

The browser 52 also preferably includes a filtering function. In accordance with one aspect of the present invention, the filtering can be accomplished in an address bar and/or by a visual tool. In accordance with a preferred embodiment, filtering is done currently using Xpath and Xquery.

The browser 52 also preferably includes a selection function. A selection may be the whole list and it's recognized by its location. A selection may be a list resulted from a filter and it's recognized by it's xpath filter. A selection may be a partial list of elements within a filter result (it will be recognized as separate selections). A selection may be a single element and it's recognized by an ID sub element, or ID attribute. A selection may be a single or list of elements, which is recognized by the software automatically detecting filters and providing it for the user to select which filter to use as selection recognizer.

The browser 52 should also include a linking function. A link can be a static location such as an ID. A link can be a dynamic location such as a filter. A link result can be a single simple type element. A link result can be a single complex type element. A link result can be a group of elements (if the link if a dynamic link). A link display name can be a Custom Name. A link display name can be the text of a simple type. A link display name can be text of one of the elements of the result (if the result is a complex type).

This is preferably accomplished by providing an element list of the complex type element, which the user can select which one should be the display name. It is also preferred to use a filter tool to further filter the result to a single element and providing one of the options above.

The browser 52 also preferably provides a snapshot link. A snapshot link is something that can be manually updated. A snapshot link provides a user with an option when updating the content of the link, to purge the old version or to save it. The user can later recognize the versions by date. Using a snapshot link, the user can set a schedule on a stored link to automatically check if the content has changed, and update the content of the link. The user has the options to automatically save or to delete the old versions of the content.

The browser 52 preferably provides storage capabilities. Storage has special folders which can only accept elements from a specific schema, i.e., a wish list accepts only product items. Storage can also have a generic folder which accept links and content of any element. In accordance with one aspect of the present invention, storing can happen automatically such as a history of site navigation which is stored automatically in the storage, receipts of web sites are also stored in storage automatically.

Storage can also be connected with the login, so automatic storage can happen without the user's need to select a location. The construction of a browser 52 that is able to process xml files and to perform these functions is well known in the art.

Normally, the information relating to products and services at a site such as site 54 is stored in HTML files. In accordance with the present invention, however, the information is stored in XML files. In accordance with one aspect of the present invention, another site 60 is provided to manage various aspects of the present invention. One of the services provided by the site 60 is a wizard to allow sites such as site 54 to convert its HTML files to XML files.

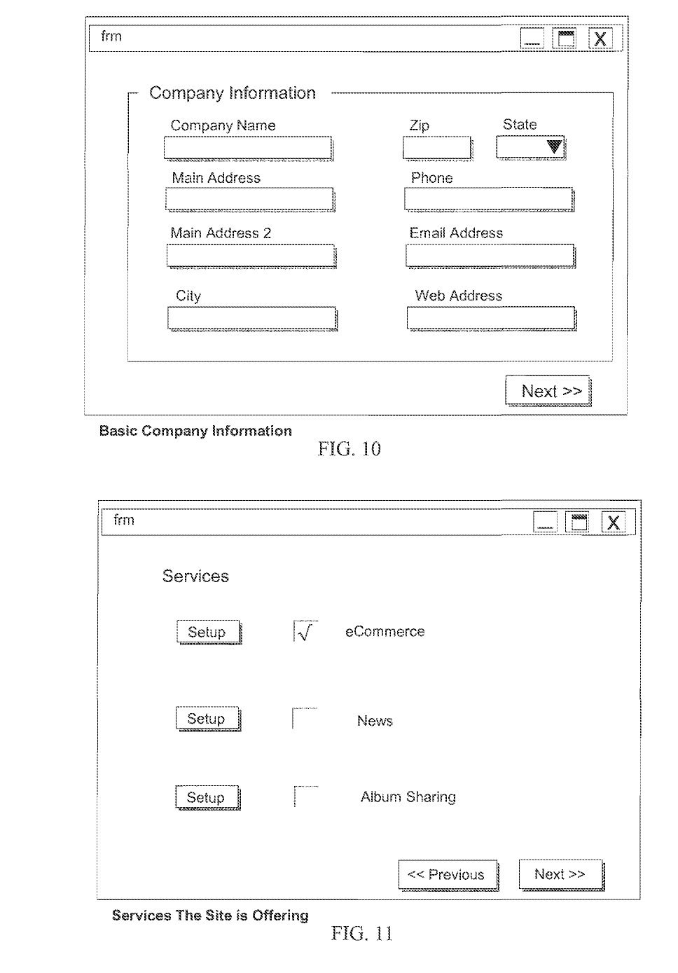

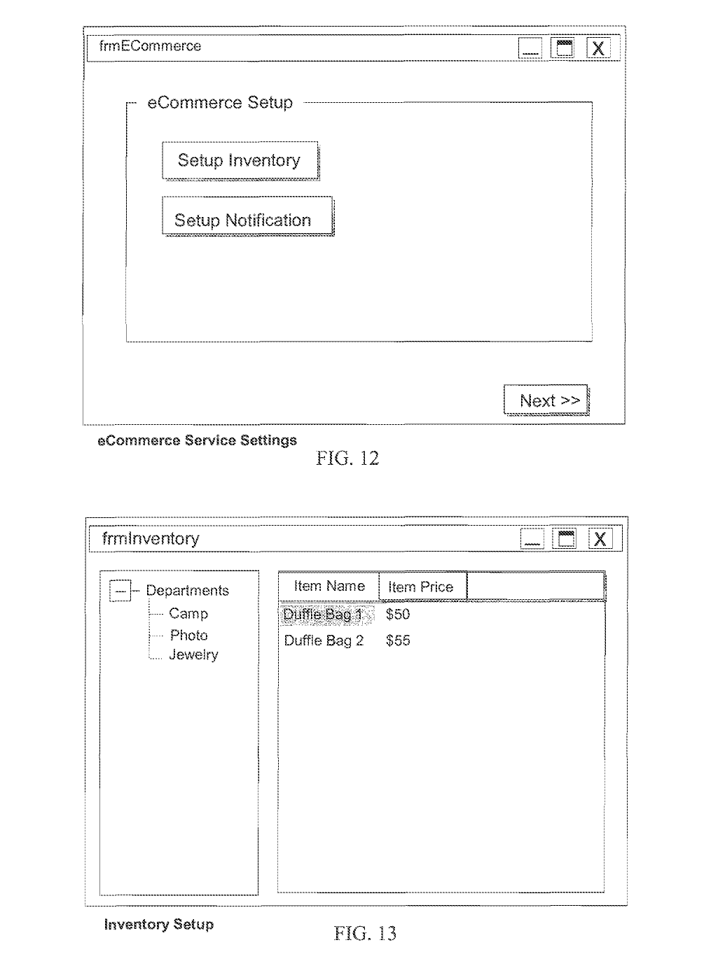

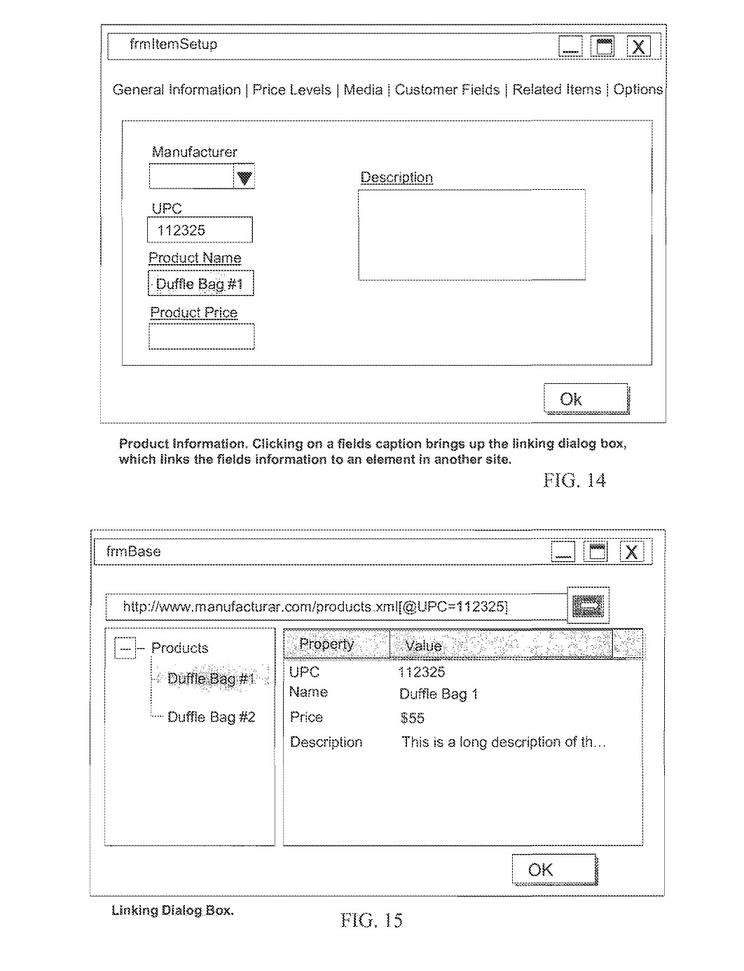

FIGS. 10 to 16 illustrate screens provided by the site 60 to allow web sites to set up their web sites to communicate in accordance with different aspects of this invention. FIG. 10 illustrates a window that allows the entry of basic information about the company offering the services. FIG. 11 illustrates the type of services that can be provided by the web site. In FIG. 11, the web site can offer eCommerce solutions, News and album sharing. FIG. 12 illustrates the initial screen for the eCommerce set up. The user can select either inventory set up or notification set up. FIG. 13 illustrates the inventory set up. A user can enter a product's name and the price, preferably but not necessarily by department. FIG. 14 illustrates a window in accordance with one aspect of the present invention wherein information about products can be entered. The information includes the manufacturer, the UPC code, a name, a price and a description. Clicking on one of the captions of a field brings up a linking dialog box that links the information in that field to an element in another site.

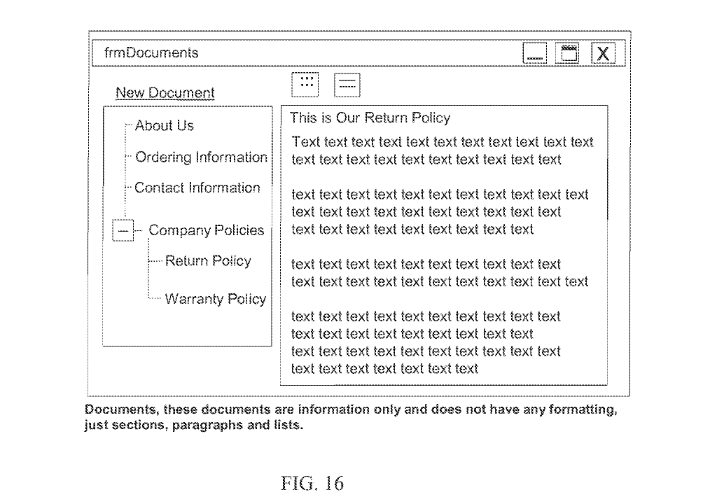

FIG. 15 illustrates the linking dialog box window that is opened when one of the fields in FIG. 14 is clicked. This window allows the specification of an address of the site to link to. This address will be, for example, a manufacturer's web site for the product being displayed in FIG. 14. FIG. 16 illustrates that there are various documents that can be provided by a web site offering products or services over the Internet in accordance with one aspect of the present invention.

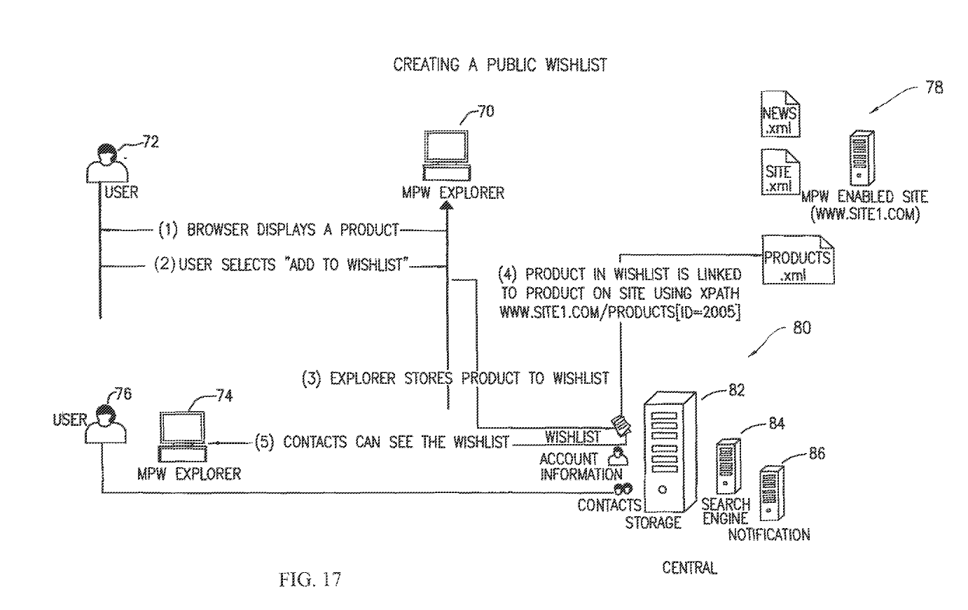

The present invention also provides a system and method for creating a wish list as illustrated in FIG. 17. The wish list allows a user to enter items or products that the user is interested in purchasing and also allows others to view the wish list and make purchases of those items. The illustrative system of FIG. 17 includes a first terminal 70 that is accessed by a first user 72 and a second terminal 74 that is accessed by a second user 76. The terminals 70 and 74 are browsers 210 that communicate via the Internet with a server 78 that offers products for sale. The terminals 70 and 74 as well as the server 78 communicate via the Internet with a central server 80. The server 78 can be any site offering a product, such as books, CDs etc., for sale. The central server 80 is maintained in accordance with one aspect of the present invention.

The server 78 is enabled in accordance with the teachings of the present invention. Thus, there is a site.xml file that indicates the services [available from the server 78] and there is a products.xml file that indicates information about the products that are available from the server 78. These files are in a standardized XML schema that can be recognized by the browsers 70 and 74.

As illustrated in FIG. 17, the server 80 preferably maintains a storage server 82, a search engine server 84 and a notification server 86. The storage server 82 maintains wish lists for various users, as explained above. The search engine server 84 is well known and provides searching capabilities of the internet. The notification server 86 tells users or subscribers to the services of the server 80 when a web site changes information on the web site. For example, a user can ask the notification server 86 to advise.

In accordance with this aspect of the present invention, referring to FIG. 17, the user 72 has requested product information from the server 78 and that information is displayed by a browser on the terminal 70 in step (1). The browser is the special browser that handles XML files and that was discussed previously. In step (2), the user 72 selects a product of interest and selects the “Add to Wish List” function on the browser. The Add to Wish List function can be implemented in a variety of ways. For example, the Add to Wish List function can be a command button, a menu item or a item on a toolbar. Once the user selects the Add to Wish List function, in step (3) the browser on the terminal 70 accesses the central server 80 to store the selected product in a Wish List file stored on the storage server 82. In step (4), the product specified in the Wish List is linked to the product on an external web site 78. This link is established and maintained when a user adds a product to his or her wish list.

In step (5), other users, such as user 76 on the terminal 74 can access the central server 80 to view the user's 72 Wish List. The user 76 accomplishes this by entering the address of the central server 80, selects the Wish List function and enters the user's 72 name. The central server 80 then accesses the user's 72 Wish List in the storage server 82 and presents that Wish List to the user 76 on the terminal 74.

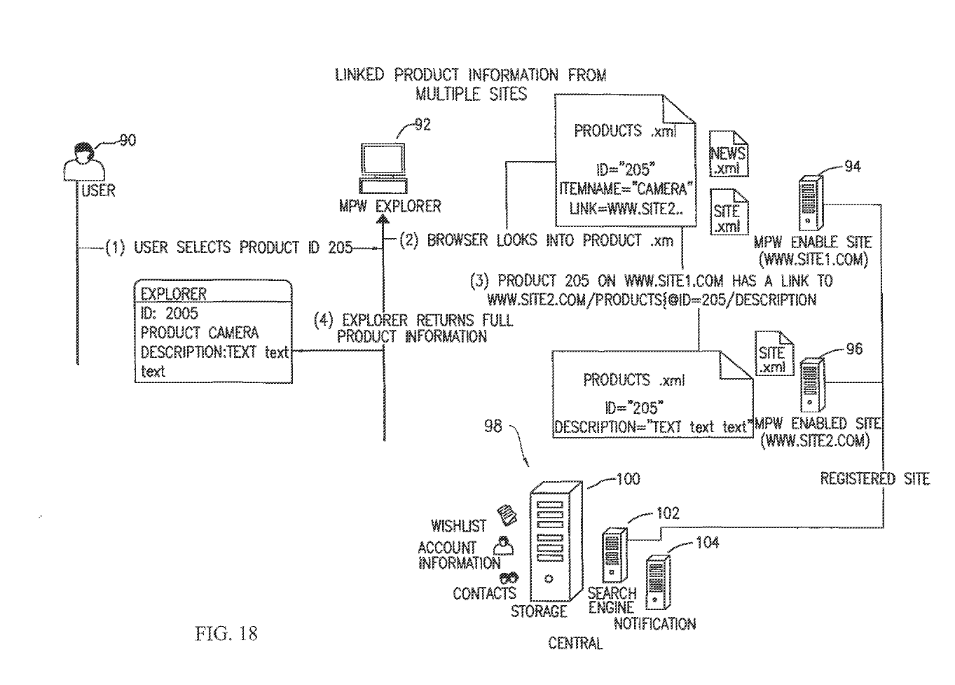

FIG. 18 illustrates a system and method for linking information from multiple Internet sites in accordance with one aspect of the present invention. A user 90 accesses the Internet via a terminal 92. A server 94, a server 96 and a system server 98 also access the Internet. The server 98 is a central server with a storage server 100, a search engine server 102 and a notification server 104. The servers 94 and 96 provide sites that sell products over the Internet and are enabled in accordance with the teachings of this disclosure. Thus, each server 94 and 96 has a site.xml file and a products.xml file. The servers 94 and 96 are registered sites with the server 98.

In step (1), as illustrated in FIG. 18, the user 90 is viewing the products provided by one of the sites 94 or 96 on a browser on the terminal 92 and selects a product of interest. In the illustrative example of FIG. 18, the user 90 selects a product with product ID 205. In step (2), the browser on the terminal 92 accesses the server 94 and examines the product.xml file. There it finds the product having product ID 205 and determines that there is a link to another web site 96. In step (3), the web site 94 accesses the web site 96 to gather the linked information. The linked information may be, for example, a description of the product generated by a manufacturer. In step (4), the web site 94 provides the information concerning the product to the terminal 92 and to the user 90.

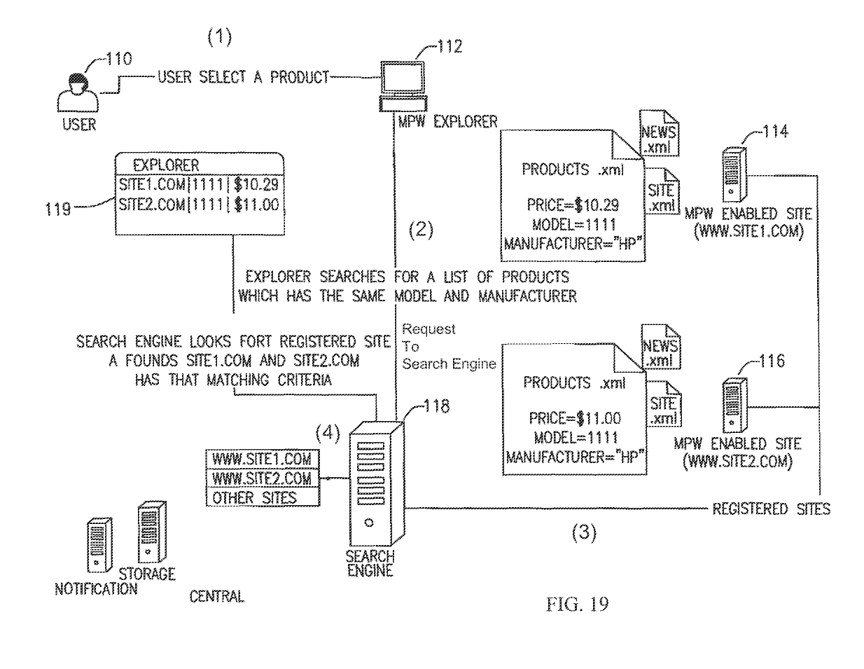

FIG. 19 illustrates another service provided by a web site in accordance with another aspect of the present invention. A user 100 selects a product in step (1) on a terminal 102. In step (2), a browser on the terminal 112 searches for a list of products that have the model number and the manufacturer specified by the user by transmitting a request to a Search Engine 118. In step (3), the Search Engine 118 requests information from a first registered site 114 and a second registered site 116. The first registered site 114 accesses its product list and provides a response to the Search Engine 118. The second registered site 116 also accesses its product list and provides a response to the Search Engine 118. In step (4) the Search Engine compiles a comparison, shown in 119, and sends it to the user's browser.

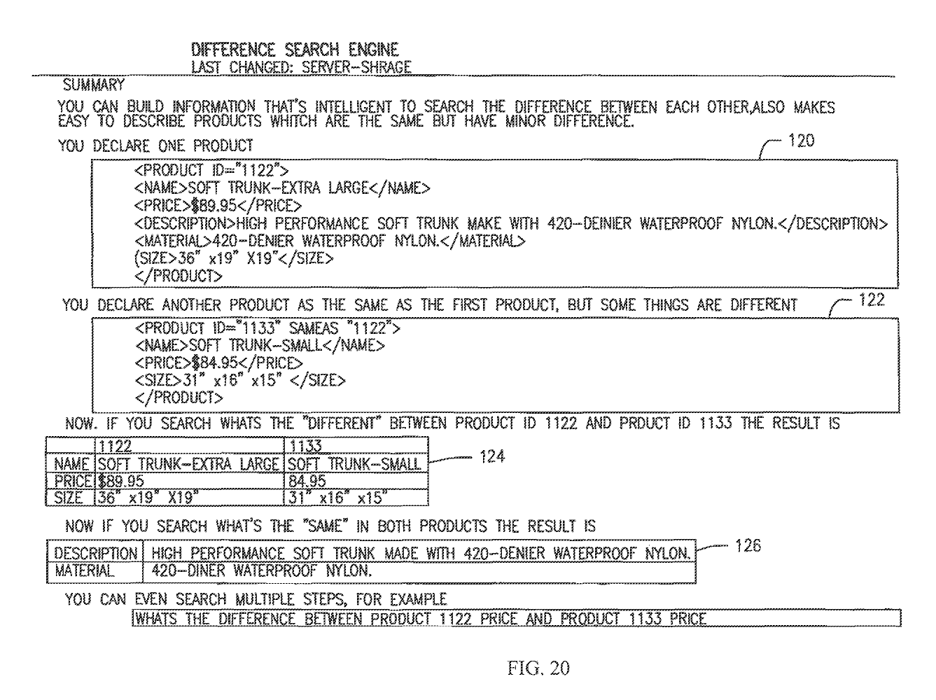

FIG. 20 illustrates a Difference Search Engine. In step 120, a first product is declared. In step 122, the same product is declared, but there are differences. In step 124, the differences are displayed. In step 126, the results that are the same are displayed.

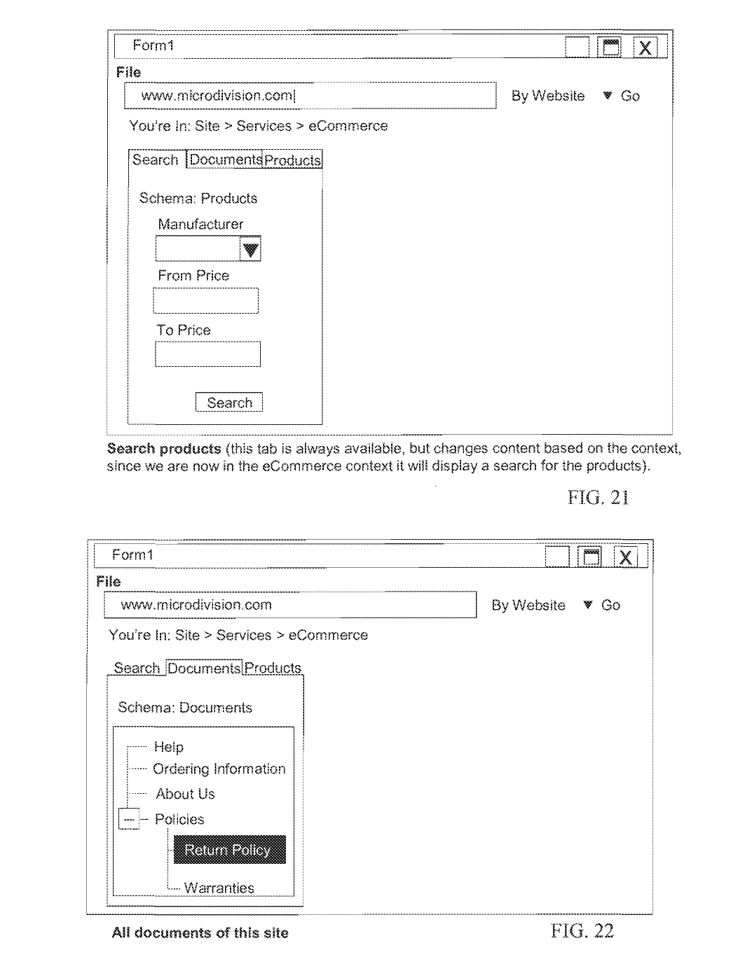

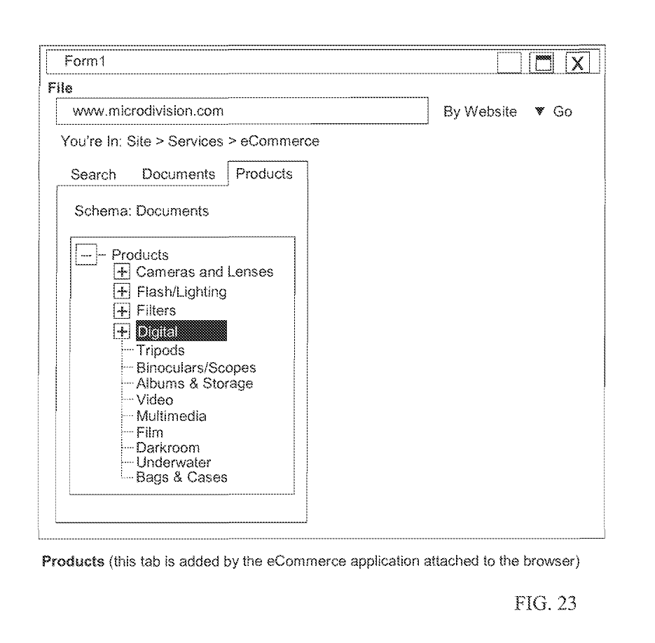

FIGS. 21 to 23 further illustrate a browser in accordance with one aspect of the present invention. FIG. 21 illustrates a search product tab. A user can enter a manufacturer, a From Price and a To Price. FIG. 22 illustrates a documents tab whereby a user can view important documents from a web site. The documents include a document explaining ordering information, an about us document, a return policy document and a warranty document. FIG. 23 illustrates a product tab. This tab can show information about products of interest to a user.

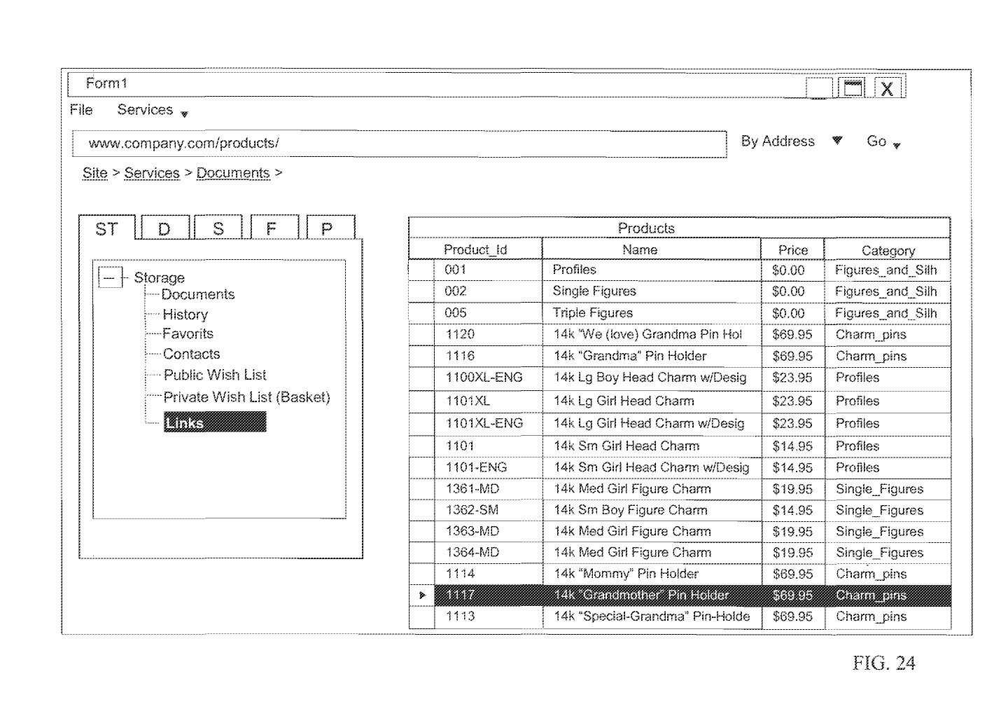

FIG. 24 illustrates a screen shot of another version of a browser. An address is specified in the top address box and the products available from that company are illustrated in the main box of the screen. The information concerning the products includes the product id, the product name, the price and a product category.

As can be seen on the left side of the screen, documents can be stored, a history of sites visited and information viewed can be stored, a favorites list can be stored, a contact list can be stored, and wish lists can be stored. The wish list can be a public wish list that is viewable by others or a private wish list for the user's own use.

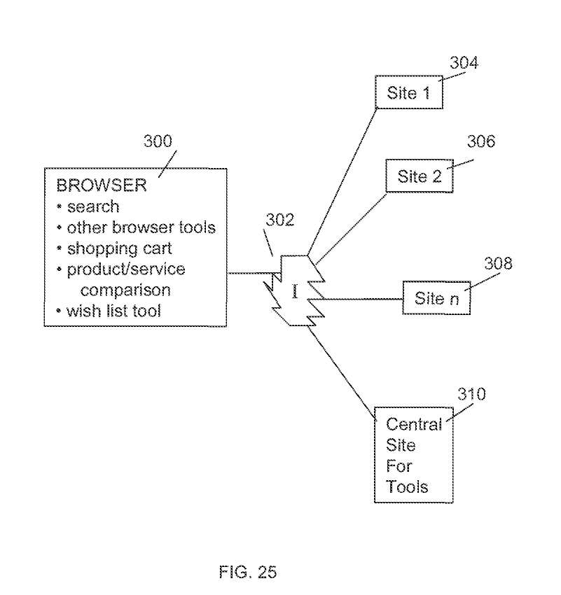

FIG. 25 illustrates another aspect of the present invention. A browser 300 is provided. The browser 300 has all of the normal browser tools, including a search function, a go to function, and others.

The browser 300 also has a shopping cart tool, a product/service comparison tools and/or a wish list tool. These tools may be provided in any combination, including individually or all together, on the same browser.

The tools, including the shopping cart tool, the product/service comparison tool and the wish list tool can be a permanent part of a browser 300. In this case, the tools are provided with the browser 300 on a computer for use whenever desired. In an alternate aspect of the present invention, the tools can be stored on a server 310 on the internet 302. When a user of the browser 300 desires to use one of the tools, the browser 300 accesses the server 310 and downloads the appropriate tool which will then reside at the browser 300 during the use of the tool.

As previously explained, the server 300 preferably communicates with files at servers 304, 306 and 308 that are maintained in a predetermined file format. This allows the tools on the browser 300 to communicate with files at each server 304, 306 and 308 in a consistent and known fashion. This also allows the same tool to be used by a browser 300 to communicate with each of the servers 304, 306 and 308.

The wish list tool and method of using the tool in accordance with various aspects of the present invention are illustrated in FIG. 17. The product comparison tool and method of using the tool in accordance with various aspects of the present invention are illustrated in FIG. 19. The shopping cart tool provided in the browser 300 can be similar to any of the known shopping cart tools that are normally provided at each of the individual sites 304, 306 and 308. The difference is that the shopping cart tool of the present invention is used by the browser 300 to communicate with all of the sites 304, 306 and 308—the browser 300 does not have to download a different shopping cart tool from each of the internet sites 304, 306 and 308. The shopping cart tool of the present invention communicates with the files having a pre-defined format at the sites 304, 306 and 308.

Thus, the browser software application, in accordance with the present invention includes a means for means for browsing a world wide web and a shopping cart tool. The browser software application can include all of the other tools normally provided with a browser software application.

The browser software application preferably includes the ability to communicate with internet sites that maintain the usual HTML files. It also includes the ability to communicate with the specially formatted files of the present invention, such as the XML files previously described.

The browser software application of the present invention, including the shopping cart tool, resides on a computer. A server can be connected to the computer via an internet connection, and the shopping cart tool enables a product to be selected and purchased from the server.

The product comparison tool and the wish list tool can also be provided individually on the browser or in any combination with the browser tools described herein.

The present invention also contemplates methods using the tools described herein. For example, a method of buying a product from a personal computer running a browser software application that has a resident shopping cart tool is contemplated. Similarly, a method of generating a wish list from a personal computer running a browser software application that has a resident wish list tool is contemplated. Further, a method of generating a wish list from a personal computer running a browser software application that has a resident product comparison tool contemplated.

The present invention also provides a method of shopping on the internet wherein a shopping cart tool is downloaded from a first internet site 310 and information about one or more products is downloaded from at least a second internet site 304 or 306 or 308 over the internet 302. At least one of the one or more products can then be ordered using the shopping cart tool from computer 300.

As illustrated in FIG. 25, the computer 300 preferably, but not necessarily, has a browser that downloads the shopping cart tool from the internet site 310. The browser can display an icon and step of downloading the shopping cart tool from the internet site 310 occurs when the icon is selected.

The first internet site can provide one or more additional tools to the browser at computer 300. Any of the tools discussed herein can be provided to the computer 300 from the central internet site 310. These tools include, but are not limited to, a wish list tool and a product comparison tool. The central internet site 310 can also provide memory to the browser at the computer 300.

A plurality of instances of the shopping cart tool can be run on the browser at the computer 300 once the shopping cart tool is available.

In accordance with a further aspect of the present invention, a shopping cart tool can be downloaded from the central internet site 310. Then information regarding a first product from a second internet site 304 can be downloaded to the computer 300 and the now resident shopping cart tool so that the information can be displayed by the shopping cart tool on the computer 300. Then information regarding a second product from a third internet site 306 can downloaded to the shopping cart tool on the computer 300. That information can also be displayed by the shopping cart tool.

The display of information by the shopping cart tool is conventional in the sense that the information (quantity, product description and price) can be displayed.

In accordance with a further aspect of the present invention, information about the second product can be downloaded from another internet site 308. Prices from both internet sites 306 and 308 can be displayed by the shopping cart tool on the computer 300. Alternatively, the lowest price can be displayed. Thus, the price for the product from one internet site can replace the price for the product from the other internet site if the price is less.

In accordance with another aspect of the present invention, a system in communication with a first internet site is provided. The system includes a computer and a software application running on the computer. An icon is displayed by the software application. When the icon is selected, the software application opens a shopping cart tool from the first internet site. The software application then downloads information regarding a first product from a second internet site. It can also download information regarding a second product from the second internet site. It can further download information regarding a second product from a third internet site.

This application incorporates both U.S. Provisional Patent Application Ser. No. 60/761,098, filed Jan. 23, 2006 and U.S. Provisional Patent Application Ser. No. 60/806,300, filed Jun. 30, 2006 by reference in their entirety.

Thus, in accordance with one aspect of the present invention, a software application can include a means for browsing a world wide web such as a browser and a shopping cart tool. The software application can be loaded on a computer. The computer can be connected to a server via an internet connection and the shopping cart tool can enable a product to be purchased from the server. The shopping cart tool allows products to be selected and purchased. The means for browsing can include a search tool and a browsing tool. The software application can include a product comparison tool as well as a wish list tool.

In accordance another aspect of the present invention, a method of buying a product from a personal computer running a software application is provided. The method can include accessing a server over an internet connection from the personal computer using the software application, selecting one or more products available from the server from the personal computer using the software application and buying the selected one or more products from the personal computer using the software application. The method can include searching over the internet connection with the personal computer using the software application. Products available from a plurality of servers from the personal computer can be compared using the software application. A wish list of desired products from the personal computer can be generated using the software application.

In accordance with a further aspect of the present invention, a software application is provided that include means for browsing a world wide web and a product comparison tool. The software application is loaded on the computer and a plurality of servers can be connected to the computer via an internet connection at various times and the product comparison tool enables a comparison of a first product available from a first server to a second product available from a second server. The means for browsing can include a search tool and/or a browsing tool and/or a wish list tool.

In accordance with a further aspect of the present invention, a method of buying a product from a personal computer running a software application is provided. The method includes accessing a plurality of servers over an internet connection from the personal computer using the software application, selecting a product available from the plurality of servers using the software application and comparing the product available from the plurality of servers using the software application. The software application searches over the internet connection with the personal computer using the software application. A wish list of desired products can be generated from the personal computer using the software application.

In accordance with a further aspect of the present invention, a software application is provided that includes a means for browsing a world wide web, such as a browser, and a wish list tool. The software application can be loaded on the computer. A plurality of servers can be connected to the computer via an internet connection at various times and the wish list enables products from the plurality of servers to be saved in a list. Means, such as a computer connection, are provided to allow the saved list to be view by a third party. The means for browsing can include a search tool and a browsing tool.

In accordance with yet another aspect of the present invention, a method of selecting one or more products from a personal computer running a software application is provided. The method can include accessing a plurality of servers over an internet connection from the personal computer using the software application, selecting one or more products available from the plurality of servers using the software application and listing the selected one or more products using the software application. The method involves searching over the internet connection with the personal computer using the software application. Products available from a plurality of servers from the personal computer are compared using the software application.

In accordance with a further aspect of the present invention, a method of shopping on the internet provides the following steps. A shopping cart tool is downloaded from a first internet site and information about one or more products is downloaded from at least a second internet site. The method further contemplates ordering at least one of the one or more products using the shopping cart tool. A browser can be used to download the shopping cart tool. The browser can include an icon and step of downloading the shopping cart tool can occur when the icon is selected. The first internet site can provide one or more additional tools to the browser. For example, the first internet site can provide a wish list tool to the browser. It can provide a product comparison tool to the browser. It can provide memory to the browser. There can also be a plurality of instances of the shopping cart tool running on the browser. Additionally, information regarding a first product from the second internet site and information regarding a second product from a third internet site can be downloaded to the shopping cart. The shopping cart tool can receive information regarding a first product from the second internet site, display a price for the first product from the second internet site, receive information regarding the second product from a third internet site and display a price for the first product from the third internet site. In accordance with one embodiment, the price for the first product from the third internet site replaces the price for the first product from the second internet site if the price for the first product from the third internet site is less than the price for the first product from the second internet site. Thus, the shopping cart tool can determine a price for one or more products.

In accordance with another aspect of the present invention, a system includes a personal computer, means for downloading a shopping cart tool from a first internet site and means for downloading information about one or more products from at least a second internet site. The one or more products can be ordered using the shopping cart tool. A browser can be provided on the computer and the browser can download the shopping cart tool. The browser can include an icon and step of downloading the shopping cart tool can occur when the icon is selected. The first internet site can provide one or more additional tools to the browser, such as a wish list tool, a product comparison tool to the browser and/or memory. A plurality of instances of the shopping cart tool can be run on the browser.

Information regarding a first product from the second internet site and information regarding a second product from a third internet site can be downloaded to the shopping cart. The shopping cart tool can receive information regarding a first product from the second internet site, display a price for the first product from the second internet site, receive information regarding the second product from a third internet site and display a price for the first product from the third internet site. The price for the first product from the third internet site replaces the price for the first product from the second internet site if the price for the first product from the third internet site is less than the price for the first product from the second internet site.

A further aspect of the present invention provides a system in communication with a first internet site that includes a computer, a software application running on the computer, and an icon displayed by the software application, wherein when the icon is selected, the software application opens a shopping cart tool from the first internet site. The software application can download information regarding a first product from a second internet site, can download information regarding a second product from the second internet site and can download information regarding a second product from a third internet site.

While there have been shown, described and pointed out fundamental novel features of the invention as applied to preferred embodiments thereof, it will be understood that various omissions and substitutions and changes in the form and details of the device illustrated and in its operation may be made by those skilled in the art without departing from the spirit of the invention. It is the intention, therefore, to be limited only as indicated by the scope of the claims appended hereto.

1. A software application, comprising:
means for browsing a world wide web; and
a shopping cart tool.

2. The claim of claim 1, comprising:
a computer,
wherein the software application is loaded on the computer.

3. The claim of claim 2, comprising:
a server, the server being connected to the computer via an internet connection;
wherein the shopping cart tool enables a product to be purchased from the server.

4. The claim of claim 1, wherein the shopping cart tool allows products to be selected and purchased.

5. The claim of claim 1, wherein the means for browsing includes a search tool and a browsing tool.

6. The claim of claim 1, comprising a product comparison tool.

7. The claim of claim 1, comprising a wish list tool.

8. The claim of claim 6, comprising a wish list tool.

9. A method of buying a product from a personal computer running a software application, comprising:
accessing a server over an internet connection from the personal computer using the software application; and
selecting one or more products available from the server from the personal computer using the software application; and
buying the selected one or more products from the personal computer using the software application.

10. The method of claim 9, comprising searching over the internet connection with the personal computer using the software application.

11. The method of claim 9, comprising comparing products available from a plurality of servers from the personal computer using the software application.

12. The method of claim 9, comprising generating a wish list of desired products from the personal computer using the software application.

13. The method of claim 11, comprising generating a wish list of desired products from the personal computer using the software application.

14. A software application, comprising:
means for browsing a world wide web; and
a product comparison tool.

15. The claim of claim 14, comprising:
a computer,
wherein the software application is loaded on the computer.

16. The claim of claim 15, comprising:
a plurality of servers, the plurality of servers being connected to the computer via an internet connection at various times;
wherein the product comparison tool enables a comparison of a first product available from a first server to a second product available from a second server.

17. The claim of claim 14, wherein the means for browsing includes a search tool and a browsing tool.

18. The claim of claim 14, comprising a wish list tool.

19. A method of buying a product from a personal computer running a software application, comprising:
accessing a plurality of servers over an internet connection from the personal computer using the software application; and
selecting a product available from the plurality of servers using the software application; and
comparing the product available from the plurality of servers using the software application.

20. The method of claim 19, comprising searching over the internet connection with the personal computer using the software application.

21. The method of claim 19, comprising generating a wish list of desired products from the personal computer using the software application.

22. A software application, comprising:
means for browsing a world wide web; and
wish list tool.

23. The claim of claim 22, comprising:
a computer,
wherein the software application is loaded on the computer.

24. The claim of claim 23, comprising:
a plurality of servers, the plurality of servers being connected to the computer via an internet connection at various times;
wherein the wish list enables products from the plurality of servers to be saved in a list.

25. The claim of claim 24, comprising means to allow the saved list to be view by a third party.

26. The claim of claim 22, wherein the means for browsing includes a search tool and a browsing tool.

27. A method of selecting one or more products from a personal computer running a software application, comprising:
accessing a plurality of servers over an internet connection from the personal computer using the software application; and
selecting one or more products available from the plurality of servers using the software application; and
listing the selected one or more products using the software application.

28. The method of claim 27, comprising searching over the internet connection with the personal computer using the software application.

29. The method of claim 27, comprising comparing products available from a plurality of servers from the personal computer using the software application.

30. A method of shopping on the internet, comprising:
downloading a shopping cart tool from a first internet site; and
downloading information about one or more products from at least a second internet site.

31. The method of claim 30, comprising ordering at least one of the one or more products using the shopping cart tool.

32. The method of claim 30, wherein a browser downloads the shopping cart tool.

33. The method of claim 31, wherein a browser downloads the shopping cart tool.

34. The method of claim 32, wherein the browser includes an icon and step of downloading the shopping cart tool occurs when the icon is selected.

35. The method of claim 34, wherein the first internet site provides one or more additional tools to the browser.

36. The method of claim 34, wherein the first internet site provides a wish list tool to the browser.

37. The method of claim 34, wherein the first internet site provides a product comparison tool to the browser.

38. The method of claim 35, wherein the first internet site provides memory to the browser.

39. The method of claim 30, wherein a plurality of instances of the shopping cart tool are run on the browser.

40. The method of claim 30, wherein a plurality of instances of the shopping cart tool are run on the browser.

41. The method of claim 30, wherein information regarding a first product from the second internet site and information regarding a second product from a third internet site are downloaded to the shopping cart.

42. The method of claim 32, wherein information regarding a first product from the second internet site and information regarding a second product from a third internet site are downloaded to the shopping cart tool.

43. The method of claim 42, wherein the shopping cart tool:
receives information regarding a first product from the second internet site;
displays a price for the first product from the second internet site;
receives information regarding the second product from a third internet site; and
displays a price for the first product from the third internet site.

44. The method of claim 43, wherein the price for the first product from the third internet site replaces the price for the first product from the second internet site if the price for the first product from the third internet site is less than the price for the first product from the second internet site.

45. The method of claim 32, wherein the shopping cart tool determines a price for one or more products.

46. A system, comprising:
a personal computer;
means for downloading a shopping cart tool from a first internet site; and
means for downloading information about one or more products from at least a second internet site.

47. The system of claim 46, wherein one of the one or more products can be ordered using the shopping cart tool.

48. The system of claim 46, wherein a browser downloads the shopping cart tool:

49. The system of claim 47, wherein a browser downloads the shopping cart tool:

50. The system of claim 48, wherein the browser includes an icon and step of downloading the shopping cart tool occurs when the icon is selected.

51. The system of claim 50, wherein the first internet site provides one or more additional tools to the browser.

52. The system of claim 50, wherein the first internet site provides a wish list tool to the browser.

53. The system of claim 50, wherein the first internet site provides a product comparison tool to the browser.

54. The system of claim 51, wherein the first internet site provides memory to the browser.

55. The system of claim 46, wherein a plurality of instances of the shopping cart tool are run on the browser.

56. The system of claim 46, wherein a plurality of instances of the shopping cart tool are run on the browser.

57. The system of claim 46, wherein information regarding a first product from the second internet site and information regarding a second product from a third internet site are downloaded to the shopping cart.

58. The system of claim 48, wherein information regarding a first product from the second internet site and information regarding a second product from a third internet site are downloaded to the shopping cart tool.

59. The system of claim 58, wherein the shopping cart tool:
receives information regarding a first product from the second internet site;
displays a price for the first product from the second internet site;
receives information regarding the second product from a third internet site; and
displays a price for the first product from the third internet site.

60. The system of claim 59, wherein the price for the first product from the third internet site replaces the price for the first product from the second internet site if the price for the first product from the third internet site is less than the price for the first product from the second internet site.

61. The system of claim 46, wherein the shopping cart tool determines a price for one or more products.

62. A system in communication with a first internet site, comprising:
a computer;
a software application running on the computer;
an icon displayed by the software application;
wherein when the icon is selected, the software application opens a shopping cart tool from the first internet site.

63. The system of claim 62, wherein the software application downloads information regarding a first product from a second internet site.

64. The system of claim 63, wherein the software application downloads information regarding a second product from the second internet site.

65. The system of claim 63, wherein the software application downloads information regarding a second product from a third internet site.
